(19) United States
(12) Patent Application Publication
(10) Pub. No.: US 2002/0080039 A1
(43) Pub. Date: Jun. 27, 2002

(54) Multiple area smoke detector system

(76) Inventor: Bernard Vining, Chicago, IL (US)

Correspondence Address: BERNARD VINING, 6419 SOUTH TROY STREET, CHICAGO, IL, 60629, US

(21) Appl. No.: 09/747,268

(22) Filed: Dec. 26, 2000

Related U.S. Application Data
(60) Provisional application No. 60/222,300, filed on Aug. 1, 2000.

(51) Int. Cl. G08B 17/10

(52) U.S. Cl. 340/628; 340/539; 340/10.1

(57) ABSTRACT

A smoke detector system with radio frequency (rf) communication abilitiy, designed to communicate with smoke detectors in a number of different rooms or areas in the same building, by means of radio frequency (rf)signal. After the false alarm time delayed period ends, when the existence of smoke is detected, all rooms or areas are alerted of the present of smoke in the building and the individual room where smoke was detected is identified by visual signal on that smoke detector unit. The system can be reset, by manual (rf) switch on smoke detectors units or hand held (rf) remote control unit switch. System smoke detectors units used in a single building to protect, are (rf) tuned and codelocked, whereas, they communicate only with smoke detectors units in single building.

### FIELD OF THE INVENTION

The present invention relates to smoke detector systems in general; and more particularly, it relates to a smoke detector system useful in a building having multipe rooms or areas in which it is desired to isolate the source of the smoke to a single room while at the same time alerting persons in all of the rooms of the existence of detected smoke (or fire). With the present system, a person in a room in which the smoke originates can tell immediately by means of a visual signal that the source of is in a room which does not contain the source of smoke, the person is also immediately informed of that fact. This permits the person to search through other rooms to see, by means of visual indicators, exactly which room contains the source of smoke.

### SUMMARY OF THE INVENTION

In typical residential or commercial smoke detecting systems, there is a separate smoke detector in one or more rooms. If a smoke detector is in the same room as the source of smoke, the smoke detector becomes energized and usually generates a distinctive audible signal to alert others. The primary shortcoming of this type of system is that persons in another room may have difficulty in hearing the audible alarm either because the source of smoke is located in a remote room, or because ambient noise levels interfere with the audible alarm of the smoke detector. On the other hand, if a global audible is generated in all rooms, it can be difficult to identify quickly in which room the smoke is located.

The present invention is designed to overcome these shortcomings by having a separate smoke detector in each of a number of different rooms or areas in a building, but the smoke detector of the instant invention is designed to communicate with the smoke detectors in other rooms in the same building by means of a radio frequency (rf) signal. Thus, all rooms are alerted that smoke has been detected in a room; and the individual room in which the smoke is present is identified by visual signals on that unit.

That is, each room has its own smoke detector, and each smoke detector in any given room includes both a transmitter circuit and a receiver circuit. When smoke is detected in a room, a signal is generated to actuate a timer which provides a short, intentional delay to aviod false alarms. When the timer circuit times out, it actuates an rf transmitter circuit and at the same, flashing lamp circuit is actuates to indicate that partcular room contains the source of smoke. The transmitter circuit generates a radio frequency signal actuates a receiver circuit in each of the smoke detector units in the other rooms of the house. Each of the receiver circuit, in turn, actuates a local tone generator to generate an audible signal to alert occupants of that particular room that a source of smoke has been detected in the house. The occupant may then look at the smoke detector unit in that room and see whether its indicator light is lit. If it is not, that indicates that the source of smoke is in another room, and the occupant must then go to the other rooms in which smoke detector units are present to identify visually which unit has its indicator light illuminated and that room will be the room in which the source of the smoke is located. The system also contains circuitry for resetting the individual smoke detector units and system.

Other features and advantages of the present invention will be apparent to persons skilled in the art from the following detailed disclosure of one embodiment accompanied by the attached drawings where identical reference numerals will refer to like parts in the various views.

### BRIEF DESCRIPTION OF THE DRAWINGS

The first drawing is an electrical schematic diagram of a smoke detector unit which would be located in a single room or area, and a demonstration drawing of a building with multiple rooms, illustrating the embodiment functions and communication capability of a single smoke detector when existence of smoke is detected.

### DETAILED DESCRIPTION OF THE ILLUSTRATED EMBODIMENT

Turning now to the first drawing, there is shown an electrical schematic diagram partly in functional block form, of a smoke detector unit incorporating the present invention. That is, a unit such as shown in the drawing would be located in each of the rooms of a house, apartment or other building intended to be protected. It is not necessary, according to the owener or user's desires, that every room contain such a detector unit, although that may be preferred in most instances.

In the drawing, reference numeral 10 designates a source smoke detector. The source smoke detector 10 is of conventional design and may be obtained commercially, as is the case with all of the individual circuits disclosed herein. As known, the source smoke detector 10 includes an ionization chamber in which ionized particles are created and the particles move under an electric field, thereby creating an electrical current. When smoke enters the ionization chamber, the smoke particles attached to the ionized particles, neutralizing the electrical charge and thereby decreasing the magnitude of the current flowing. The smoke detector senses the reduction in electrical current between plates in the ionization chamber and generates an output signal coupled through a diode 11 to an output line 12. When smoke is detected by the source smoke detector 10, a positive-going pulse is generated on the output line 12 and fed to the input of an inverter 13, the output of which is coupled to the input of a first timer circuit 15. The output signal of the inverter 13 actuates the first time circuit 15 when a pulse is detected from the source smoke detector 10. the output signal of the first timer circuit 15 is a high pulse which is coupled through an inverter 17 and an inverter 18 to the input of a second timer circuit 22.

The first circuit 15 is a conventional monostable circuit know in the art as a 555 timer, and it generates an positive output pulse for designed thirty seconds. The output pulse of the first timer circuit 15 coupled through the inverter 17, is fed along a line 26 to the input of a NAND (i. e., inverting “and”) gate 27, the output of which is fed to an input of a second NAND gate 29, the output of which is fed to the reset input RS of the first timer 15. Timer circuit 22 is a convententional monstable circuit known in the art as a 555 timer designed to generate an output pulse for approximately twenty-four seconds when it is energized. The output of time 22 is a positive pulse generated on two output lines, 22A and 22B.

The output line 22A is connected to a first lamp L1 and to an inverter 31, the output of which is connected to the input of a third timer 32, the output of which is connected to a second lamp L2. The timer circuit 32 is a conventional monostable circuit know in the art as a 555 timer, and it generates an positive output pusle for approximately two-hundred and four seconds. Relay 33 has normally open (N/O) contacts 34A and normally closed (N/C) contacts 34B acting as the output. The N/O contacts 34A of the relay 33 of the receiver circuit 35 is connected to the other input of the gate 29 as well as to the input of a tone generator circuit 37. The normally-closed contacts 34B of relay 33 of the receiver circuit is connected to the power input of the source smoke detector 10 along a line 36, and to the other input of the inverting gate 27 along a line 38.

The second output 22B of the timer circuit 22 is connected to the input of a transmitter circuit 39 having a reset switch 40. The transmitter circuit 39 and the receiver circuit 35 are tuned to operate on the same frequency. Moreover, all of the transmitter circuit and receiver circuits in the other units located in other rooms in a building intended to be protected, have similar transmitters and receivers, all operating on a common frequency. The transmitter and receivers discussed may be conventional circuits such as Code Lock Receivers for K6706 and Code Lock Two Channel Transmitters, both of which are commercially available.

Operation

Before describing the operation of the circuitry in detail, it will be pointed out that the function of the twenty-four second timer 22 is to avoid “false alarms” which may be created by cigarette smoke or cooking, as commonly occurs in conventional smoke detectors, but which do not indicate presence of a fire or harmful smoke.

When the source smoke detector 10 detects the existence of smoke, it energizes or triggers, through the inverter 13, the timer circuit 15. The output of the timer circuit 15, in turn, triggers the input of the second or twenty-four timer circuit 22. During the twenty-four second interval in which the timer 22 is energized, the light L1 is on, indicating that the local smoke detector has been actuated. At the same time, the output of the timer 22A, in turn, triggers the input of the third or two-hundred and four seconds timer circuit 32. During the two-hundred and four seconds time interval in which the timer 32 is energized, the light L2 is on, also indicating that the local smoke detector has been actuated and remains on until timer circuit 32 time out.

When the timer circuit 22 time out, if the system has not been reset, L2 connected to line 22A is turn-off during this period and a low signal is generated on the line 22B to energize transmitter circuit 39. The transmitter circuit circuit 39, when energized, generates a radio frequency signal to actuate the receiver circuit 35 as well as all other receiver circuits in the other smoke detector units in other rooms or areas being protected by the same system. When the receiver circuit 35 (and the associated receiver circiuts in other protected rooms) is energized, normally open contacts 34A close, voltage than is apply to tone generators circuits and a voltage is fed to gate 29 of the source smoke detector 10 that detected the existence of smoke. The output of the gate 29 resets the timer circuit 15 after it has time out (vis gate 27). At the same time, the output signal on the normally closed contacts 34B of the receiver circuit 35 remove the power from the lead 36 to the source smoke detector 10, thereby inhibiting further actuation of the system until it is reset.

The system is reset by means of the reset 40 in the transmitter circuit 39. To reset the system when the twenty-four second timer 22 has been actuated, the reset switch 40 is pressed twice in succession. The first time the switch 40 is pressed, the transmitter circuit 39 was not generating an output RF signal because the twenty-four second period had not yet expired. Thus, the transmitter circuit 39, upon the first actuation of switch 40 during the twenty-four second timer period of timer 22, and generates a RF signal which actuates the receiver circuit and cause it to switch states. This switching of the states of the receiver circuit 35 disables the source smoke detector 10 and also enables the gate 27.

The second time the reset switch 40 is pressed during the twenty-four second period, the receiver circuit is placed in its original condition, and the gate 29 is actuated to reset the timer circuit 15.

To reset the unit after the twenty-four second period has expired, the reset switch 40 need be pressed only once. This cause the transmitter 39 to discontinue transmitting the RF signal, and this in turn causes the receiver 35 to switch back to its original state, thereby resetting the timer 15.

If user desire to reset individual or system from another source smoke detector, other than the detector that was energize by existence of smoke. Than by pressing switch 40 manual switch or by hand held RF remote control switch 40 in the same order as described above.

### BRIEF DESCRIPTION OF THE DRAWINGS

As mention, The second drawing, is an demonstration drawing of a building with multiple rooms or areas, illustrating the embodiment functions and communication capability of a single smoke detector when existence of smoke is detected.

### BRIEF DESCRIPTION OF DEMONSTRATION EMBODIMENT

Figure one drawing, illustrated the embodiment function of a single source smoke detector when existence of smoke is first detected during the twenty-four second “false alarm” time interval.

Assuming D4 source smoke detector reference numeral 10 is energized from existence of smoke, D4 alarm sounds and L1 12 & L2 14 visual lamps indicators is turned-on during this period, alerting area where existence of smoke is detected.

Figure two drawing, illustrated the embodiment function of a single source smoke detector when existence of smoke detected after the twenty-four second “false alarm” time interval have ended.

If system have not been reset before the twenty-four second “false alarm” time interval have end. D4 source smoke detector 10 and L1 12 visual lamp indicator is turn-off at the end of twenty-four second time interval, in at the same time, transmitter 16 is energized, generating a radio frequency signal, actuate receiver 18 and associated receivers circuits in D1 20, D2 30, and D3 40 switching tone generators, that generate an audible signal in areas where existence of smoke not detected, in at the same time, generator generate signal in area where existence of smoke was detected, continuously alerting this area.

L2 14 visual lamp indicator remains on visable, until timer interval time out. When resetting during or after the twenty-four second time interval, L2 visual lamp indicator remains on visable, until timer interval, time out.

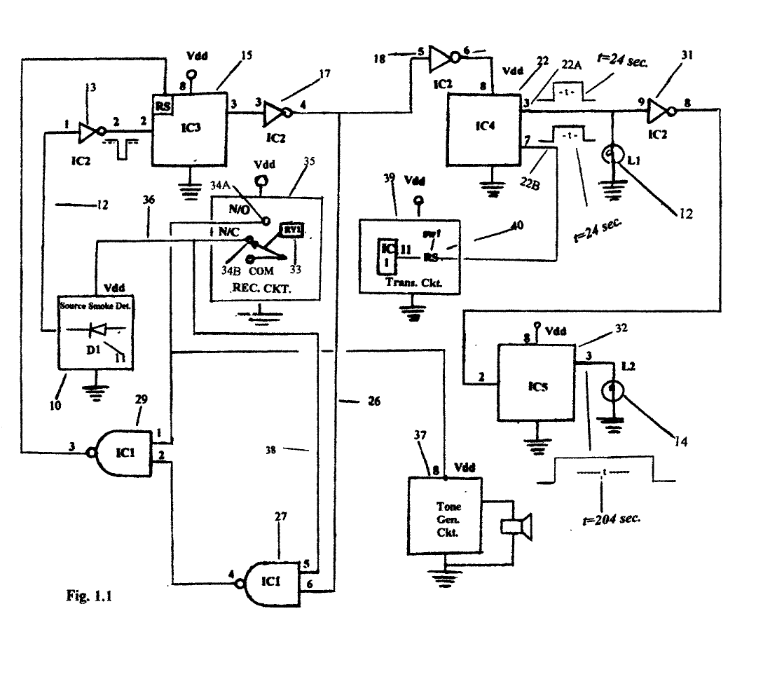

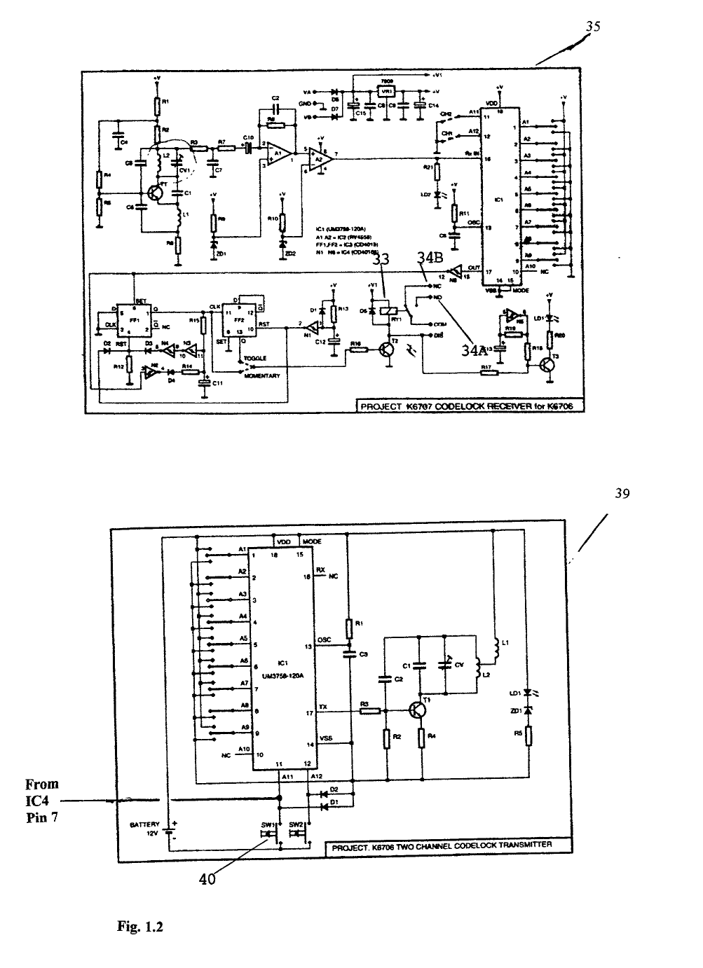

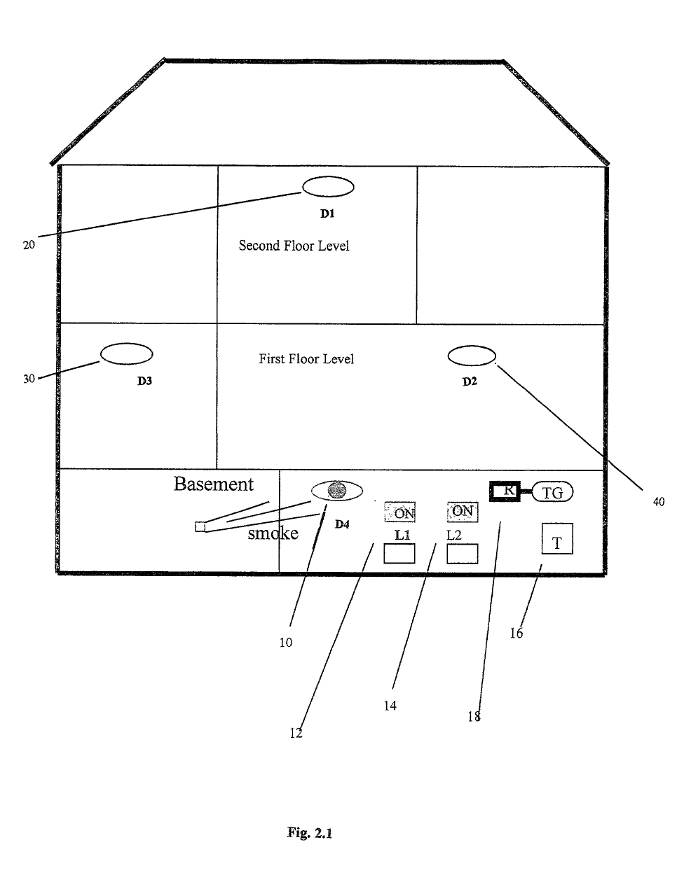

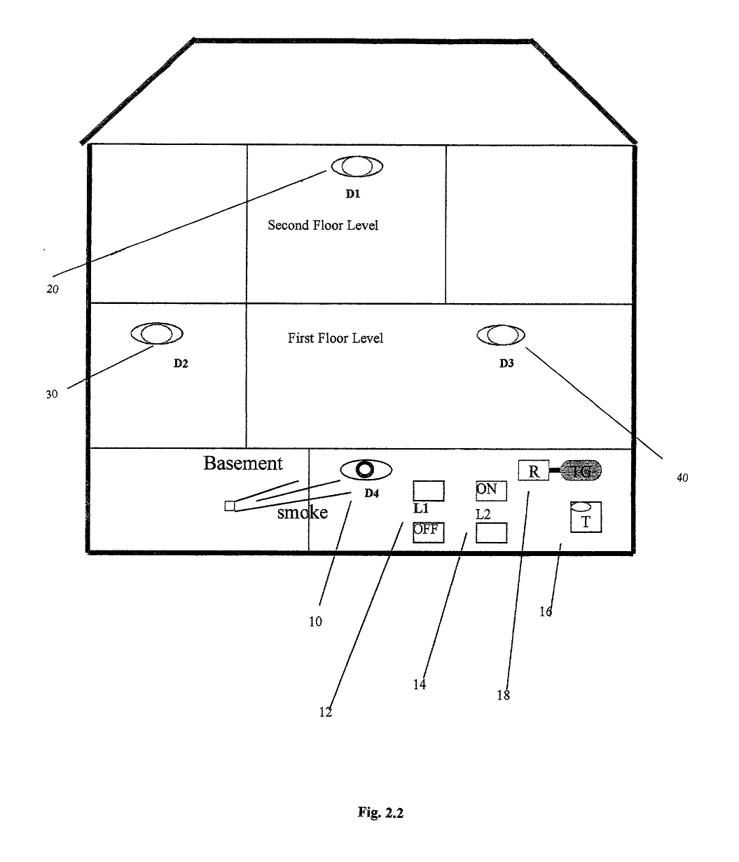

This same application apply for the other source smoke detectors shown here in FIG. 1 and FIG. 2 when existence of smoke is detected.

### BRIEF DESCRIPTION OF MARKET DETECTORS

The illustration in figure A and B demonstrates the difference between the commerical detectors on market today and the communication capability of the All Alert Multiple Area Smoke Detector System when existence of smoke is detected.

### BRIEF DESCRIPTION OF DEMONSTRATION EMBODIMENT

FIG. 2.1 drawings, illustrates the embodiment function of a single source smoke detector when existence of smoke is first detected during the twenty-four second “false alarm” time interval.

Assuming source smoke detector reference numeral 10 is energized from existence of smoke, 10 audible alarm sounds and 12 & 14 visual lamps indicators is turned-on during this period, alerting the area where existence of smoke is detected.

FIG. 2.2 drawing, illustrates the embodiment function of a single source smoke detector when existence of smoke is detected after the twenty-four second “false alarm” time interval have end.

If system have not been reset before the twenty-four second “false alarm” time interval have end. Source smoke detector reference numeral 10 and visual lamp indicator 12 is turn-off at the end of twenty-four second time interval, visual lamp indicator 14 remains on identifying the triggered source smoke detector, at the same time, transmitter 16 is energized, generating a radio frequency signal, actuate receiver 18 and associated receivers circuits 20, 30, and 40 switching tone generators circuits, that generates an audible signal, alerting all areas of the existence of smoke. This same application apply for the other source smoke detectors shown herein FIG. 2.1 and FIG. 2.2.

### BRIEF DESCRIPTION OF DEMONSTRATION DIFFERENCE

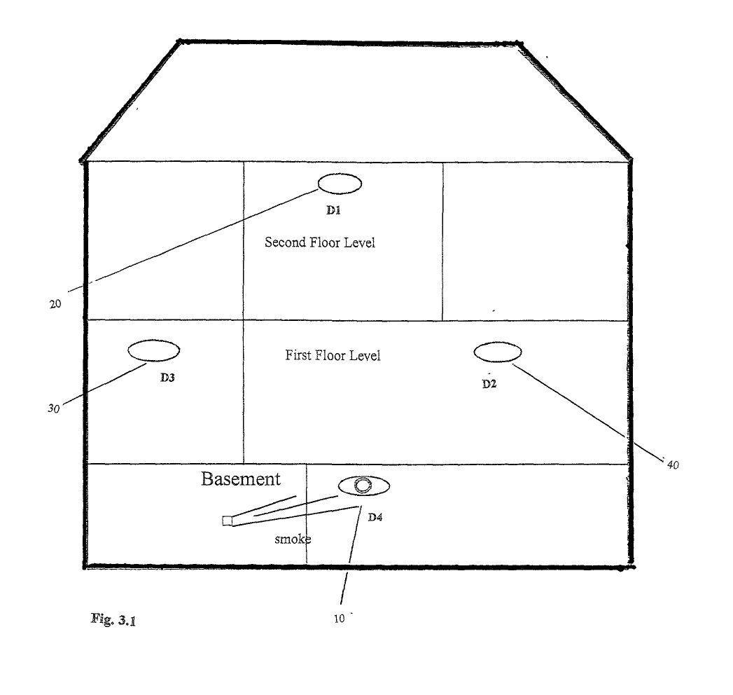

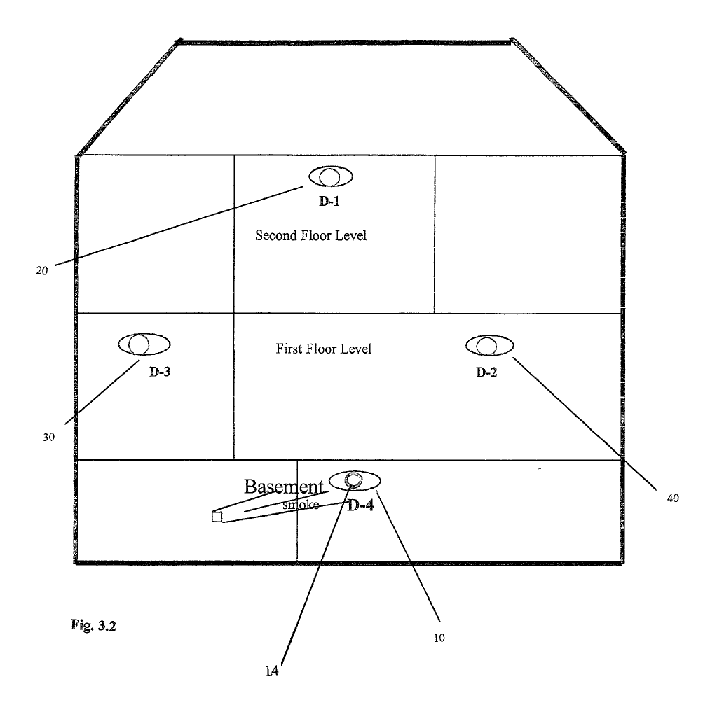

The illustration in FIG. 3.1 shows how commercial smoke detector on market today works when energized by the existence of smoke. Assuming smoke detector reference numberal 10 is energized from the existence of smoke, 10 audible alarm sounds, alerting area to be protected.

The illustration in FIG. 3.2 shows how the multiple area smoke detector system works when energized by the existence of smoke. Again, assuming reference numberal 10 is energized by the existence of smoke. After the intentional false alarm period ends, visual signal indicator 14 remains on identifying triggered source smoke detector and at the same time 10 actuates an rf signal which actuates 20, 30, and 40 which generates an audible signal alerting these areas, while continuously alerting the area where the existence of smoke was detected.

I claim:

1) Using an inverted DC voltage Pulse generated by a conventional design commercial smoke Detector (Ionization Chamber), when energize by the existence of smoke to trigger start a monostable 555 timer circuit, that generate an positive-going output voltage pulse designed for thirty seconds.

2) The positive-going output voltage pulse generate by the first timer in claim 1, coupled through two not gate inverters powered-up the second monostable 555 timer circuit, that is design to produce a dual twenty-four seconds positive-going output voltage pulses (A and B).

3) The (A) output voltage pulse in claim 2, of the second 555 timer circuit provide the voltage pulse for the twenty-four second false alarm visual lamp indicator, and at the same time through an inverted voltage input pulse trigger starting the third monostable 555 timer circuit. The two-hundred and four seconds positive going output voltage pulse produced by the third 555 timer circuit is design to provide the voltage pulse for the second lamp indicator, that visual indicate which source smoke detector have been triggered by the existence of smoke after the twenty-four seconds false alarm time interval have ended.

4) The (B) output voltage pulse in claim 2, of the second 555 timer circuit is connected to the input trigger circuit of the transmitter. At the end of the twenty-four second time interval the voltage pulse goes low energizing an commercial RF tuned codelocked transmitter circuit, generating an RF Signal that actuate commercial RF tuned codelocked receivers circuits used When receivers circuits is energized, a voltage is switched on by the receivers circuits powering-up tone generators circuits that produce an audible signal in the areas to be protected.

5) Smoke detectors used to protect areas are embodiment with RF tuned codelocked transmitters and receivers.

6) The system contains circuitry for resetting the individual smoke detector and system. The system and individual smoke detector trigger by the existence of smoke can be reset from another smoke detector other than the one that was trigger by the existence of smoke if user desire. The system can be reset by manual RF tuned codelocked switches on commercial transmitters, or by hand held RF tuned codelocked remote control unit on commercial transmitter.

7) Resetting individual smoke detector and system in claim 6. To reset individual smoke detector that is triggered by the existence of smoke and system before the twenty-four seconds false alarm period end, by pressing twice in succession manual RF tuned codelocked switch on commercial transmitters, or by hand held RF tuned codelocked remote control unit. To reset system after twenty-four seconds false alarm period have ended. By pressing once manual RF tuned codelocked switch on commercial transmitters, or by hand held RF tuned codelocked remote control unit.

8) The development as claim in 1, 2, 3, 4, 5 6 and 7 can be used as an individual smoke detector with the same capability to protect a single area, by having RF tuned codelocked transmitter and receiver embodied.

9) An individual smoke detector as claim in 8, have the same capability of resetting single smoke detector with RF tuned codelocked remote control unit, and manual switch on transmitter.
